(19) United States
(12) Patent Application Publication
(10) Pub. No.: US 2011/0143155 A1
(43) Pub. Date: Jun. 16, 2011

(54) Multilayer film structure

(75) Inventors: Norman Dorien Joseph Aubee, Okotoks (CA); XiaoChuan Wang, Calgary (CA)

(73) Assignee: NOVA Chemicals (International) S.A.

(21) Appl. No.: 12/928,191

(22) Filed: Dec. 6, 2010

(30) Foreign Application Priority Data
Dec. 10, 2009 (CA) 2,688,092

(51) Int. Cl. B32B 27/08

(52) U.S. Cl. 428/474.4; 428/516

(57) ABSTRACT

Multilayer “barrier” films which have excellent Water Vapor Transmission Rate (WVTR) performance are prepared using a core layer which comprises a blend of two different high density polyethylenes (HDPEs) and an organic nucleating agent; a first skin layer which comprises a non-nucleated, ethylene/alpha olefin copolymer having a density of from 0.950 to 0.955 g/cc and a second skin layer. The films are suitable for the preparation of packages for dry foods such as crackers and breakfast cereals.

### FIELD OF THE INVENTION

This invention relates to multilayer plastic film having high barrier properties. The film is especially suitable for the packaging of dry foods such as crackers and breakfast cereals.

### BACKGROUND OF THE INVENTION

Plastic films having gas barrier properties are widely used in packaging for dry foods. The films should have a low Water Vapor Transmission Rate (WVTR) and a low Oxygen Transmission Rate (OTR). Aroma barrier is also desirable.

The paper packaging that was originally used in these applications was partially replaced by cellophane, but cellophane is expensive and difficult to process.

Barrier films prepared from high density polyethylene (HDPE) offer an alternative to paper or cellophane. HDPE films offer a good balance between cost and performance. However, when additional barrier and/or toughness is required, it is known to prepare multilayer films which contain layers made of more expensive barrier resins (such as ethylene-vinyl alcohol (EVOH); polyamide (nylon); polyesters; ethylene-vinyl acetate (EVA); or polyvinyldiene chloride (pvdc)) and/or layers of stronger/tougher resins such as ionomers or very low density linear polyethylenes. Sealant layers made from EVA, ionomer, “high pressure low density polyethylene” (“LD”) or plastomers are also employed in multilayer structures.

The expensive barrier resins listed above (polyamide, EVOH, polyesters and pvdc) tend to be more polar than HDPE. This can cause adhesion problems between layers of polar and non-polar resins in multilayer film structures. Accordingly, “tie layers” or adhesives may be used between the layers to reduce the probability that the layers separate from one another.

Monolayer HDPE films are inexpensive, easy to prepare and offer moderate resistance to water vapor and oxygen transmission. Moreover, it is simple to provide increased barrier properties by just increasing the thickness of the film. However, the mechanical properties (such as tear strength and impact strength) and sealing properties of HDPE film are comparatively low so multilayer films are widely used.

Thus, the design of barrier films involves a cost/benefit analysis—with the low cost of HDPE resin being balanced against the better performance of the more expensive, polar resins. Another way to lower the cost of the film is to simply use less material—by manufacturing a thinner or “down gauged” film.

Examples of multilayer barrier films that use HDPE are disclosed in U.S Pat. No. 4,188,441 (Cook); U.S. Pat. No. 4,254,169 (Schroeder); and U.S. Pat. No. 6,045,882 (Sandford). Commonly assigned U.S. patent application no. 20090029182 (“182 application” published 29 Jan. 2009) also discloses a similar multilayer barrier film. The present films provide improved mechanical properties and reduced “dusting” in comparison to the films of the '182 application, while still maintaining excellent barrier performance.

### SUMMARY OF THE INVENTION

The present invention provides a barrier film comprising a core layer, a first skin layer and a second skin layer, wherein said core layer consists essentially of a blend of:

a) a first high density polyethylene resin;

b) a second high density polyethylene resin having a melt index, I2, at least 50% greater than said first high density polyethylene resin; and

c) a barrier nucleating agent, and wherein the first skin layer is a non-nucleated ethylene/alpha olefin copolymer having a density of from 0.950 to 0.955 g/cc.

There are three essential features to the present invention, namely:

1) The use of the nucleating agent in a blend of the two HDPE resins, which increases WVTR performance (in comparison to the use of the nucleating agent in a single HDPE resin).

2) The use of the nucleating agent in the “core layer” of a multilayer structure. While not wishing to be bound by theory, it is possible that the skin layers provide a type of “insulation” for the core layer during the cooling process while the multilayer film is being formed—thereby increasing the effectiveness of the nucleating agent during the cooling process.

3) The use of an ethylene copolymer having a density of from 0.950 to 0.955 g/cc in a skin layer.

The present multilayer films offer two types of advantages:

1) Low cost films may be prepared by “down gauging”—i.e. the present invention allows the preparation of low cost, thin films having WVTR performance which is acceptable for many applications; and

2) Higher performance films may be prepared without requiring as much of the more expensive resins—for example, a thicker layer of the nucleated blend of HDPE resins may allow the use of less polyamide (or EVA, pvdc, EVOH, etc.) in a higher performance multilayer film.

### DETAILED DESCRIPTION OF THE PREFERRED EMBODIMENTS

### A. Core Layer HDPE Blend

The HDPEs that are used in the core layer of the films of this invention must have a density of at least 0.950 grams per cubic centimeter (g/cc) as determined by ASTM D1505. Each of the preferred HDPE resins have a density of greater than 0.955 g/cc and the most preferred type of HDPE is a homopolymer of ethylene having a density of greater than 0.958 g/cc.

Two different HDPE resins are used in the core layer. The first HDPE has a comparatively low melt index. As used herein, the term “melt index” is meant to refer to the value obtained by ASTM D 1238 (when conducted at 190° C., using a 2.16 kg weight). This term is also referenced to herein as “I₂” (expressed in grams of polyethylene which flow during the 10 minute testing period, or “gram/10 minutes”). As will be recognized by those skilled in the art, melt index, I₂, is in general inversely proportional to molecular weight. Thus, the first HDPE has a comparatively low melt index (or, alternatively stated, a comparatively high molecular weight) in comparison to the second HDPE.

The absolute value of I₂ for the second HDPE is preferably greater than 5 grams/10 minutes. However, the “relative value” of I₂ for the second HDPE is also critical—it must be at least 50% higher than the I₂ value for the first HDPE. Thus, for the purpose of illustration: if the I₂ of the first HDPE is 2 grams/10 minutes, then the I₂ value for the second HDPE must be at least 3 grams/10 minutes. It is highly preferred that the melt index of the second HDPE is at least 10 times greater than the melt index of the first HDPE—for example, if the melt index, (I₂), of the first HDPE is 1 gram/10 minutes, then the melt index of the second HDPE is preferably greater than 10 grams/10 minutes.

The blend of HDPE resins used in the core layer may also contain additional HDPE resins and/or other polymers (subject to the conditions described above concerning the relative I₂ values of two HDPE resins).

The molecular weight distribution for the HDPEs [which is determined by dividing the weight average molecular weight (Mw) by number average molecular weight (Mn), where Mw and Mn are determined by gel permeation chromatography, according to ASTM D 6474-99] of each HDPE is preferably from 2 to 20, especially from 2 to 4. While not wishing to be bound by theory, it is believed that a low Mw/Mn value (from 2 to 4) for the second HDPE may improve the nucleation rate and overall barrier performance of blown films prepared according to the process of this invention.

The “overall” blend composition used in the core layer of the films of this invention is formed by blending together the at least two HDPEs. This overall composition preferably has a melt index (ASTM D 1238, measured at 190° C. with a 2.16 kg load) of from 0.5 to 10 grams/10 minutes (especially from 0.8 to 8 grams/10 minutes).

The blends may be made by any blending process, such as: 1) physical blending of particulate resin; 2) co-feed of different HDPE resins to a common extruder; 3) melt mixing (in any conventional polymer mixing apparatus); 4) solution blending; or, 5) a polymerization process which employs 2 or more reactors.

In general, the blends preferably contain from 10 to 70 weight % of the first HDPE (which has the lower melt index) and from 90 to 30 weight % of the second HDPE.

One HDPE composition is prepared by melt blending the following two blend components in an extruder:

from 70 to 30 weight % of a second HDPE having a melt index, I₂, of from 15-30 grams/10 minutes and a density of from 0.950 to 0.960 g/cc with from 30 to 70 weight % of a first HDPE having a melt index, I₂, of from 0.8 to 2 grams/10 minutes and a density of from 0.955 to 0.965 g/cc.

An example of a commercially available HDPE which is suitable as the second HDPE is sold under the trademark SCLAIR™ 79F, which is prepared by the homopolymerization of ethylene with a conventional Ziegler Natta catalyst. It has a typical melt index of 18 grams/10 minutes and a typical density of 0.963 g/cc and a typical molecular weight distribution of about 2.7.

Examples of commercially available HDPE resins which are suitable for the first HDPE include (with typical melt index and density values shown in brackets):

SCLAIR™ 19G (melt index=1.2 grams/10 minutes, density=0.962 g/cc);

MARFLEX™ 9659 (available from Chevron Phillips, melt index=1 grams/10 minutes, density=0.962 g/cc); and

ALATHON™ L 5885 (available from Equistar, melt index=0.9 grams/10 minutes, density=0.958 g/cc).

A highly preferred HDPE blend is prepared by a solution polymerization process using two reactors that operate under different polymerization conditions. This provides a uniform, in situ blend of the HDPE blend components. An example of this process is described in published U.S. patent application 20060047078 (Swabey et al.), the disclosure of which is incorporated herein by reference. The use of the “dual reactor” process also facilitates the preparation of blends which have very different melt index values. It is highly preferred to use a blend (prepared by the dual reactor process) in which the first HDPE blend component has a melt index (I₂) value of less than 0.5 g/10 minutes and the second HDPE blend component has an 1₂ value of greater than 100 g/10 minutes. In one preferred embodiment, the second HDPE component has an I₂ in excess of 1000 g/10 minutes. The amount of the first HDPE blend component of these blends is preferably from 40 to 60 weight % (with the second blend component making the balance to 100 weight %). The overall HDPE blend composition preferably has a MWD (Mw/Mn) of from 3 to 20.

### B. Organic Nucleating Agents as Barrier Nucleating Agents

The term organic nucleating agent, as used herein, is meant to convey its conventional meaning to those skilled in the art of preparing nucleated polyolefin compositions, namely an organic additive that changes the crystallization behavior of a polymer as the polymer melt is cooled.

Nucleating agents are widely used to prepare polypropylene molding compositions and to improve the molding characteristics of polyethylene terphlate (PET).

A review of nucleating agents is provided in U.S. Pat. Nos. 5,981,636; 6,465,551 and 6,599,971, the disclosures of which are incorporated herein by reference.

The term “organic” means that the nucleating agent contains carbon and hydrogen (and is intended to exclude simple minerals such as talc and calcium carbonate that provide some nucleation).

Examples of conventional organic nucleating agents which are commercially available and in widespread use as polypropylene additives are the dibenzylidene sorbital esters (such as the products sold under the trademark Millad™ 3988 by Milliken Chemical and Irgaclear™ by Ciba Specialty Chemicals). The nucleating agents which are preferably used in the present invention are generally referred to as “high performance nucleating agents” in literature relating to polypropylene. The term “barrier nucleating agent”, (as used herein), is meant to describe a nucleating agent which improves (reduces) the moisture vapor transmission rate (MVTR) of a film prepared from HDPE. This may be readily determined by: 1) preparing a monolayer HDPE film having a thickness of 1.5-2 mils in a conventional blown film process in the absence of a nucleator; 2) preparing a second film of the same thickness (with 1000 parts per million by weight of the organic nucleator being well dispersed in the HDPE) under the same conditions used to prepare the first film. If the MVTR of the second film is lower than that of the first (preferably, at least 5-10% lower), then the nucleator is a “barrier nucleating agent” that is suitable for use in the present invention.

High performance, organic nucleating agents which have a very high melting point have recently been developed. These nucleating agents are sometimes referred to as “insoluble organic” nucleating agents—to generally indicate that they do not melt disperse in polyethylene during polyolefin extrusion operations. In general, these insoluble organic nucleating agents either do not have a true melting point (i.e. they decompose prior to melting) or have a melting point greater than 300° C. or, alternatively stated, a melting/decomposition temperature of greater than 300° C.

The barrier nucleating agents are preferably well dispersed in the HDPE polyethylene composition of the core layer of the films of this invention. The amount of organic barrier nucleating agent used is comparatively small—from 100 to 3000 parts by million per weight (based on the weight of the polyethylene) so it will be appreciated by those skilled in the art that some care must be taken to ensure that the nucleating agent is well dispersed. It is preferred to add the nucleating agent in finely divided form (less than 50 microns, especially less than 10 microns) to the polyethylene to facilitate mixing. This type of “physical blend” (i.e. a mixture of the nucleating agent and the resin in solid form) is generally preferable to the use of a “masterbatch” of the nucleator (where the term “masterbatch” refers to the practice of first melt mixing the additive—the nucleator, in this case—with a small amount of HDPE resin—then melt mixing the “masterbatch” with the remaining bulk of the HDPE resin).

Examples of high performance nucleating agents which may be suitable for use in the present invention include the cyclic organic structures disclosed in U.S. Pat. No. 5,981,636 (and salts thereof, such as disodium bicyclo [2.2.1] heptene dicarboxylate);

the saturated versions of the structures disclosed in U.S. Pat. No. 5,981,636 (as disclosed in U.S. Pat. No. 6,465,551; Zhao et al., to Milliken); the salts of certain cyclic dicarboxylic acids having a hexahydrophtalic acid structure (or “HHPA” structure) as disclosed in U.S. Pat. No. 6,599,971 (Dotson et al., to Milliken); and phosphate esters, such as those disclosed in U.S. Pat. No. 5,342,868 and those sold under the trade names NA-11 and NA-21 by Asahi Denka Kogyo. Preferred barrier nucleating agents are cylic dicarboxylates and the salts thereof, especially the divalent metal or metalloid salts, (particularly, calcium salts) of the HHPA structures disclosed in U.S. Pat. No. 6,599,971. For clarity, the HHPA structure generally comprises a ring structure with six carbon atoms in the ring and two carboxylic acid groups which are substituents on adjacent atoms of the ring structure. The other four carbon atoms in the ring may be substituted, as disclosed in U.S. Pat. No. 6,599,971. A preferred example is I,2—cyclohexanedicarboxylic acid, calcium salt (CAS registry number 491589-22-1).

Nucleating agents are also comparatively expensive, which provides another reason to use them efficiently. While not wishing to be bound by theory, it is believed that the use of the nucleating agent in the “core” layer of the present multilayer structures may improve the efficiency of the nucleating agent (in comparison to the use of the nucleating agent in a skin layer) as the skin layers may provide some insulation to the core layer during the cooling/freezing step when the films are made (thereby providing additional time for the nucleating agent to function effectively).

### C. Skin Layer Ethylene Copolymer

One skin layer of the filing of this invention must be made from an ethylene alpha olefin copolymer. As used herein, the term “ethylene/alpha olefin copolymer” is intended to convey its standard meaning, namely a polymer that is prepared by the copolymerization of ethylene with a copolymerizable alpha olefin. Preferred alpha olefins are selected from the group consisting of butene-1, hexene-1 and octene-1. The density of this polymer must be between 0.950 g/cc and 0.955 g/cc. Highly preferred ethylene copolymers are further characterized by having a melt index, I₂, of from 0.5 g/cc to 3 g/cc. The use of ethylene copolymers of this type in the skin layer has been found to produce multilayer films having a desired balance of mechanical properties in comparison to films in which the skin layer is a homopolymer or a blend of homopolymers. In addition, the use of this ethylene copolymer has been observed to improve/reduce the “dusting” which occurs when a homopolymer is used in the skin layer. (The term “dusting” refers to the tendency for small particles of the film to fracture/break off of the film surface. These particles have the appearance of dust. Further discussion of “dusting” is provided in commonly assigned U.S. patent application no. 20060246309 ('309 application). The use of talc is disclosed in the '309 application as a means to mitigate dusting. Similarly, talc may be employed in the present invention for the same reason).

The ethylene copolymer for the first skin layer may be a blend of two or more ethylene copolymers, provided that the resulting blend has a density of from 0.950 to 0.955 g/cc.

The first skin layer is also “non-nucleated”—i.e. it does not contain an organic nucleating agent as described in Part B above.

### D. Film Structure

A three layer film structure may be described as layers A-B-C, where the interval layer B (the “core” layer) is sandwiched between two external “skin” layers A and C. In many multilayer films, one (or both) of the skin layers is made from a resin which provides good seal strength and is referred to herein as a sealant layer.

Five, seven and nine layer film structures are also within the scope of this invention. As will be appreciated by those skilled in the art, it is known to prepare barrier films with excellent WVTR performance by using a core layer of nylon and skin layers made from conventional HDPE (or LLDPE) and conventional sealant resins. These structures generally require “tie layers” to prevent separation of the nylon core layer from the extra layers. For some applications, the three layer structures described above may be used instead of the 5 layer structures with a nylon (polyamide) core.

Seven layer structures allow for further design flexibility. In a preferred seven layer structure, one of the layers consist of nylon (polyamide)—or an alternative polar resin having a desired barrier property—and two tie layers which incorporate the nylon layer into the structure. Nylon is comparatively expensive and difficult to use. The (optional) 7 layer structures of this invention allow less of the nylon to be used (because of the excellent WVTR performance of the core layer of this invention).

The core layer of the multilayer films is preferably from 40 to 70 weight % of thin films (having a thickness of less than 2 mils). For all films, it is preferred that the core layer is at least 0.5 mils thick. The skin layers preferably each contain at least 10% by weight of the total resin used in the film structure, especially from 10 to 20 weight %

### E. Other Additives

The HDPE may also contain other conventional additives, especially (1) primary antioxidants (such as hindered phenols, including vitamin E); (2) secondary antioxidants (especially phosphites and phosphonites); and (3) process aids (especially fluoroelastomer and/or polyethylene glycol process aid).

### F. Film Extrusion Process

### Blown Film Process

The extrusion-blown film process is a well known process for the preparation of multilayer plastic film. The process employs multiple extruders which heat, melt and convey the molten plastics and forces them through multiple annular dies. Typical extrusion temperatures are from 330 to 500° F., especially 350 to 460° F.

The polyethylene film is drawn from the die and formed into a tube shape and eventually passed through a pair of draw or nip rollers. Internal compressed air is then introduced from the mandrel causing the tube to increase in diameter forming a “bubble” of the desired size. Thus, the blown film is stretched in two directions, namely in the axial direction (by the use of forced air which “blows out” the diameter of the bubble) and in the lengthwise direction of the bubble (by the action of a winding element which pulls the bubble through the machinery). External air is also introduced around the bubble circumference to cool the melt as it exits the die. Film width is varied by introducing more or less internal air into the bubble thus increasing or decreasing the bubble size. Film thickness is controlled primarily by increasing or decreasing the speed of the draw roll or nip roll to control the draw-down rate. Preferred multilayer films according to this invention have a total thickness of from 1 to 4 mils.

The bubble is then collapsed into two doubled layers of film immediately after passing through the draw or nip rolls. The cooled film can then be processed further by cutting or sealing to produce a variety of consumer products. While not wishing to be bound by theory, it is generally believed by those skilled in the art of manufacturing blown films that the physical properties of the finished films are influenced by both the molecular structure of the polyethylene and by the processing conditions. For example, the processing conditions are thought to influence the degree of molecular orientation (in both the machine direction and the axial or cross direction).

A balance of “machine direction” (“MD”) and “transverse direction” (“TD”—which is perpendicular to MD) molecular orientation is generally considered most desirable for key properties associated with the invention (for example, Dart Impact strength, Machine Direction and Transverse Direction tear properties).

Thus, it is recognized that these stretching forces on the “bubble” can affect the physical properties of the finished film. In particular, it is known that the “blow up ratio” (i.e. the ratio of the diameter of the blown bubble to the diameter of the annular die) can have a significant effect upon the dart impact strength and tear strength of the finished film.

Further details are provided in the following examples.

### EXAMPLES

### Example 1

Comparative Films with a Non-Nucleated Core Layer

The films were made on a three layer coextrusion film line manufactured by Brampton Engineering. Three layer films having a total thickness of 2 mils were prepared using a blow up ratio (BUR) of 2/1. Three layer films having a total thickness of 1 mil were prepared using a BUR of 1.5/1.

The “sealant” layer (i.e. one of the skin layers identified as layer C in Tables 2.1 and 2.2) was prepared from a conventional high pressure, low density polyethylene homopolymer having a melt index of about 2 grams/10 minutes. Such low density homopolymers are widely available items of commerce and typically have a density of from about 0.915 to 0.930 g/cc. The resin is dientified as “sealant LD” in the Tables. The amount of sealant layer was 15 weight % in all of the examples.

The core layer (layer B in tables 2.1 and 2.2) was a conventional high density polyethylene homopolymer having a melt index of about 1.2 g/10 minutes and a density of about 0.962 g/cc (sold under the trademark SCLAIR® 19G by NOVA Chemicals) and referred to in these examples as HDPE-1. The core layer was nucleated with 1000 parts per million by weight (ppm) “nucleating agent 1”.

The barrier nucleating agent used in this example was a salt of a cyclic dicarboxylic acid, namely the calcium salt of 1,2 cyclohexanedicarbocylic (CAS Registry number 491589-22-1, referred to in these examples as “nucleating agent 1”).

The other skin layer (layer A in Tables 1.1 and 1.2) was made from the polymers/polymer blends described below (in the amounts shown in Tables 1.1 and 1.2).

“HDPE blend” was an ethylene homopolymer blend made according to the dual reactor polymerization process generally described in U.S. patent application 2006047078 (Swabey et al.). The HDPE blend comprised about 45 weight % of a first HDPE component having a melt index (I₂) that is estimated to be less than 0.5 g/10 minutes and about 55 weight % of a second HDPE component having a melt index that is estimated to be greater than 5000 g/10 minutes. Both blend components are homopolymers. The overall blend has a melt index of about 1.2 g/10 minutes and a density of greater than 0.965 g/cc. This HDPE blend was used in the comparative examples of Tables 3.1 and 3.2 and the inventive examples.

MDPE was a conventional medium density homopolymer having a melt index of about 0.7 g/10 minutes and a density of about 0.936 g/cc (sold under the trademark SCLAIR® 14G by NOVA Chemicals).

LLDPE is a linear low density polyethylene, produced with a single site catalyst, having a melt index of about 1 g/10 minutes and a density of about 0.917 g/cc (sold under the trademark SURPASS® 117 by NOVA Chemicals.

Water Vapor Transmission Rate (“WVTR”, expressed as grams of water vapor transmitted per 100 square inches of film per day at a specified film thickness (mils), or g/100 in²/day) was measured in accordance with ASTM F1249-90 with a MOCON permatron developed by Modern Controls Inc. at conditions of 100° F. (37.8° C.) and 100% relative humidity.

TABLE 1.1
Comparative 1 mil Films

| Film/ | A (varies) | B (HDPE-1) | C (sealant LD) | WVTR |
|---|---|---|---|---|
| Layer | [wt %] | [wt %] | [wt %] | g/100 in²/day |
| 1 | HDPE-blend 30 | 55 | 15 | 0.3029 |
| 2 | LLDPE 30 | 55 | 15 | 0.4026 |
| 3 | MDPE 30 | 55 | 15 | 0.3908 |

TABLE 1.2
Comparative 2 mil Films

| Film/ | A (varies) | B (HDPE-1) | C (sealant LD) | WVTR |
|---|---|---|---|---|
| Layer | [wt %] | [wt %] | [wt %] | g/100 in²/day |
| 10 | HDPE-blend 30 | 55 | 15 | 0.0924 |
| 20 | LLDPE 30 | 55 | 15 | 0.1307 |
| 30 | MDPE 30 | 55 | 15 | 0.1179 |

### Example 2

Comparative Films with a Nucleated Core Layer

1 and 2 mil films were prepared in the same manner as described in Example 1.

The core layer for all films was prepared with a combination of “HDPE blend” and nucleating agent 1 (1000 parts per million by weight).

The sealant layer for all films was prepared with 15 weight % of the LD sealant resin used in Example 1.

The other skin layer was prepared with the same resins used in Example 1 in the amounts shown in Tables 2.1 and 2.2.

### Example 3

The three layer films shown in Table 2.2 (with the core layer comprising the above described HDPE blend) offer excellent WVTR performance and physical/mechanical properties which are acceptable for many purposes. However, the tear strengths of these films are comparatively low and the films are prone to produce “dust”.

Improved films of this invention are produced by using a skin layer comprising an ethylene/alpha olefin copolymer having a density of from 0.950 to 0.955 g/cc. An inventive film of this construction is shown in Table 3 as film 31 (in which the skin layer was prepared from an ethylene-octene resin having a density of 0.953 g/cc and a melt index, I₂, of about 1 g/10 minutes. This resin is identified as EA-1 in Table 3). The film has very good WVTR performance and a good balance of tear properties (especially a TD tear of 65 grams/mil).

The sealant layer was prepared using the same type of resin used in the previous examples (i.e. a high pressure/low density polyethylene homopolymer having a melt index of about 2 grams/10 minutes).

A comparative film (film 32 in Table 3) was prepared using the same sealant and resins used in inventive film 31. The skin layer was prepared using an ethylene/octene copolymer having a melt index of about 2 grams/10 minutes and a density of about 0.944 g/10 minutes. (This resin is identified as EA-2 in Table 3). This film also provided very good WVTR—but the tear performance of this film is inferior to the inventive film.

The Tear Strength test (which is sometimes referred to as Elmendorf Tear) was conducted according to ASTM D1922.

TABLE 2.1
Comparative 1 mil Film

| | | B (LDPE | | |
|---|---|---|---|---|
| Film/ | A (varies) | blend) | C (sealant LD) | WVTR |
| Layer | [wt %] | [wt %] | [wt %] | g/100 in²/day |
| 1 | HDPE-blend 30 | 55 | 15 | 0.1563 |
| 2 | LLDPE 30 | 55 | 15 | 0.1876 |
| 3 | MDPE 30 | 55 | 15 | 0.1923 |

TABLE 2.2
Comparative 2 mil Film

| | | B (HDPE | | |
|---|---|---|---|---|
| Film/ | A (varies) | blend) | C (sealant LD) | WVTR |
| Layer | [wt %] | [wt %] | [wt %] | g/100 in²/day |
| 10 | HDPE-blend 30 | 55 | 15 | 0.0774 |
| 20 | LLDPE 30 | 55 | 15 | 0.0887 |
| 30 | MDPE 30 | 55 | 15 | 0.0814 |

TABLE 3

| | | | | WVTR | | | ASTM |
|---|---|---|---|---|---|---|---|
| | | | | (g-mil/ | Tear | Tear | Puncture |
| | | B | C | 100 in²/ | MD | TD | Energy |
| Film | A Skin | Core | Sealant | 24 hrs) | (g) | (g) | J/min |
| 31 | EA-1 | HDPE | LD 15% | 0.0718 | 65 | 280 | 9 |
| | 40% | Blend | | | | | |
| | | 45% | | | | | |
| 32-C | EA-2 | HDPE | LD 15% | 0.0858 | 32 | 230 | 3 |
| | 20% | Blend | | | | | |
| | | 65% | | | | | |

What is claimed is:

1. A barrier film comprising a core layer, a first skin layer and a second skin layer, wherein said core layer consists essentially of a nucleated blend of:
a) a first high density polyethylene resin;
b) a second high density polyethylene resin having a melt index, I2, at least 50% greater than said first high density polyethylene resin; and
c) a barrier nucleating agent,
wherein said first skin layer comprises a non-nucleated ethylene/alpha olefin copolymer having a density of from 0.950 to 0.955 g/cc.

2. The barrier film of claim 1 wherein said nucleated blend comprises from 10 to 70 weight % of said first high density polyethylene and from 90 to 30 weight % of said second high density polyethylene.

3. The barrier resin of claim 1 wherein said nucleated blend has a melt index, I₂, of from 0.5 to 10 g/10 minutes.

4. The barrier resin of claim 1 wherein said second skin layer comprises a sealant resin selected from the group consisting of EVA, ionomer and polybutylene.

5. The barrier film of claim 1 which consists of 5 layers.

6. The barrier film of claim 1 which consists of 7 layers.

7. The barrier film of claim 1 which consists of 9 layers.

8. The barrier film of claim 6 which includes at least one layer comprising a polar polymer selected from the group consisting of polyamide, pvdc, EVA and EVOH.

9. The barrier film of claim 1 wherein said nucleating agent is a salt of a dicarboxylic acid.

10. The barrier film of claim 1 wherein said dicarboxylic acid is a cyclic dicarboxylic acid having a hexahydrophtalic structure.

11. The barrier film of claim 1 wherein said non-nucleated ethylene/alpha olefin copolymer has a melt index, I₂, of from 0.5 to 3 g/10 minutes
